(19) United States
(12) Patent Application Publication
(10) Pub. No.: US 2026/0319754 A1
(43) Pub. Date: Oct. 15, 2026

(54) API GENERATOR WITH CATEGORICAL TRANSLATION

(71) Applicant: Dell Products L.P., Round Rock, TX (US)

(72) Inventor: Ruben Michel, Hopkinton, MA (US)

(73) Assignee: Dell Products L.P., Round Rock, TX (US)

(21) Appl. No.: 19/174,220

(22) Filed: Apr. 9, 2025

(51) Int. Cl. G06F 8/20; G06F 8/30; G06F 8/41

(52) U.S. Cl. CPC G06F 8/24; G06F 8/315; G06F 8/427

(57) ABSTRACT

Given a source object model, a code generator generates a corresponding object model in a second language. The generator is a class-level functor from the first object model to the second object model. The generated object model is isomorphic to the original object model, preserving properties and relations. The class-level functor is complemented by instance-level functors, from the first language to the second language and vice versa. The two functors delegate to an intermediate binary encoding representation, which flows from a client to a server and back in a client-server invocation. The invocation is realized using REST POST, WebSockets, or other communication protocols.

### BACKGROUND

System management may be accomplished through two primary mechanisms: Graphical User Interface (GUI) and Application Programming Interface (API). In the early 2000s, stimulated by the popularity of the HTTPS protocol, a new API architecture emerged known as Representational State Transfer (REST). The REST style provides numerous advantages in defining constraints of web-based behavior, including simplicity, language independence, and reliance on popular technologies. In the context of object-oriented programming, however, REST has shortcomings that impair its use in storage management.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one embodiment, a method comprises providing a first class associated with a first object model and generating a corresponding second class associated with a second object model using a class-level mapping. One or more instances of the second class may be mapped to one or more instances of the first class using an instance-level mapping. The class-level mapping and the instance-level mapping may include a translation to an intermediary representation.

According to another embodiment, a system may include a memory and at least one processor that is operatively coupled to the memory. The at least one processor may be configured to perform the operations of providing a first class associated with a first object model and generating a corresponding second class associated with a second object model using a class-level mapping. One or more instances of the second class may be mapped to one or more instances of the first class using an instance-level mapping. The class-level mapping and the instance-level mapping may include a translation to an intermediary representation.

According to another aspect, a non-transitory computer-readable medium storing one or more processor-executable instructions, which when executed by at least one processor cause the at least one processor to perform the operations of providing a first class associated with a first object model and generating a corresponding second class associated with a second object model using a class-level mapping. One or more instances of the second class may be mapped to one or more instances of the first class using an instance-level mapping. The class-level mapping and the instance-level mapping may include a translation to an intermediary representation.

The method, system and non-transitory computer-readable medium may further include, alone or in combination, one or more of the following features. The intermediary representation may be a textual encoding. The textual encoding may be a JSON representation. The first and second object models are object-oriented programming languages. The first object model may comprise a Java object model and the second object model comprises a Python object model. The translation may comprise a recursive descent parser. The recursive descent parser may comprise an LL(1) parser. The corresponding second class may be isomorphic to the first class. The class-level mapping may be a functor.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a storage system, according to one or more aspects of the present disclosure;

FIG. 2 is a diagram of a client-server interaction, according to aspects of the disclosure;

FIG. 3 is a diagram of a translation subsystem, according to aspects of the disclosure;

FIG. 4 is a commutative diagram of an API development process, according to aspects of the disclosure;

FIG. 5 is a flow diagram of a method of developing an API, according to aspects of the disclosure;

FIG. 6 is a diagram of an example of a computing device, according to aspects of the disclosure.

### DETAILED DESCRIPTION

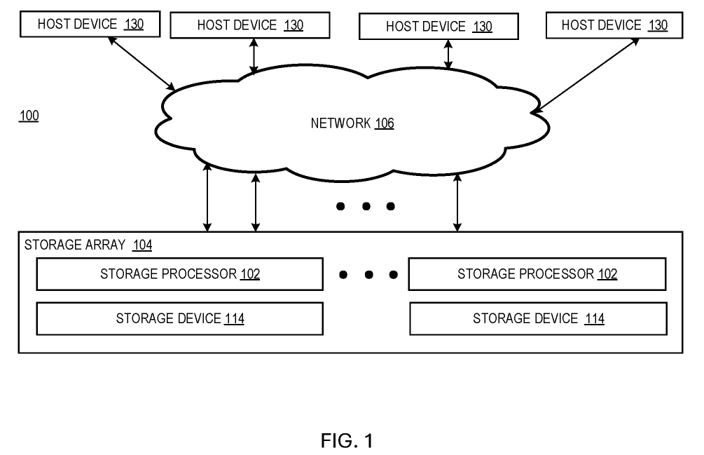

FIG. 1 is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL Technologies Powermax TM, DELL PowerStore TM, and/or any other suitable type of storage system. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

In some implementations, the storage processors 102 and the storage devices 114 may be located in geographically disparate locations. For example, the storage processors 102 may be distributed across multiple cities, countries, or continents. Similarly, the storage devices 114 (and/or the disk array enclosures of which they are part) may also be distributed across multiple cities, countries, or continents. Additionally, or alternatively, in some implementations, the storage processors 102 and the storage devices 114 may be located in the same geographic location, but in different buildings of the same campus (or different rooms of a large building).

According to aspects of the present disclosure, concepts, techniques and structures disclosed herein provide a categorical approach to developing APIs, and in particular, APIs between client and server applications. The concepts, techniques and structures described below provide a framework for API development to address a number of shortcomings in the REST architecture in object-oriented programming environments.

A storage system’s API object model (OM) may be incompatible with REST exposure. Accordingly, a separate OM may need to be developed to support REST. The two OMs need to be developed, maintained, and synchronized. Moreover, these two OMs must be individually and jointly tested, more than doubling the testing effort.

Further, as is known, the HTTPS protocol is considered to be stateless. That is a server retains no state between calls. Since REST is often layered on top of HTTPS, REST is also stateless. However, in a management storage environment, clients often require large answer sets from the server, such as, for example, retrieving volume information from a storage provider. Currently, however, the server must page that requested answer set (e.g., require a state), clearly countering the REST stateless design.

Further yet, in REST, the invoking URL often denotes traversal in the server’s REST OM. As such, the URL often exposes confidential information which HTTPS fails to conceal. For example, in a storage management application, a URL may expose an array’s identification number, storage-group names, volume numbers, or other sensitive information.

Software versioning in REST also presents certain obstacles, leading developers to include a version number in the request URL. Doing so, however, compromises backward compatibility.

Lastly, by design, REST is independent of any programming language. Therefore, both invocations and responses are specified as either strings, XML, JSON, or a certain language-independent binary encoding. To aid in parsing, the binary encodings often conform to a schema. Developing, maintaining, documenting, and using such schema adds significant overhead. For example, a client may be written in the Python language and communicating with JSON encodings. Such a client must first emit the JSON payload based on one or more Python objects, then execute the REST call, and finally parse the returned JSON payload to populate other Python objects. Consequently, dispatching a REST call carries significant, non-functional, developmental overhead.

According to one or more aspects of the present disclosure, API development may be implemented using category theory functors that map classes and instances of one object model seamlessly and invisibly to a second object model. For example, as described herein, APIs may be developed to handle interactions between client-server applications written in different object-oriented programming languages, like Java and Python. While examples given and described herein may detail categorical mappings between a server application written in Java and a client application written in Python, one skilled in the art will recognize that the concepts, techniques and structures described herein are not limited to those particular languages. One skilled in the art will further recognize that other object-oriented languages may be implemented without deviating from the scope of the disclosure.

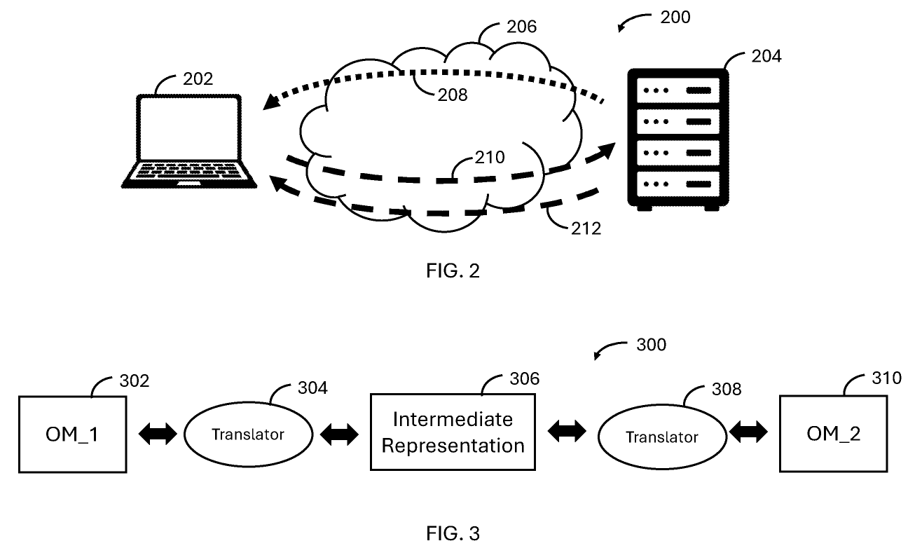

FIG. 2 is a diagram of a client-server environment 200 in which a server application 204 may be running on a server, such as for example, a storage management application, written in Java. A client application 202 may be running on a client device, but written in a different language, like Python, which communicates with the server application 204 over a network 206. With the applications written in different languages, an interface may be provided to establish and promote communication between the two, such as an API. As described herein, aspects of the present invention provide for developing APIs, using category theory, to facilitate communication between client/server applications and avoiding certain drawbacks to known API implementations, including REST APIs.

Category theory may be used to relate one or more objects, and instances, to each other using functions, or morphisms. A category may include a number of objects and the relations between each of the objects within the category (e.g., classes and relations). A morphism, according to one aspect, may include a method of a class and its result or return value, within the same category. As described herein, each of the object models may be considered categories.

One or more categories (e.g., object models) may be related to each other by one or more functors. A functor may be considered a structure preserving mapping from one category to another. As described herein, a functor may include a mapping from one object model to another. Functors may allow each object model to implement the classes within the category in terms of another object model. As but one example, a functor related to one or more classes defined in a first object model, for example Java, may allow for implementation of those classes in another object model, like Python. That is, the functors may provide a translation of one class defined according to one object model to a second class defined in a second object model.

According to one aspect, the server application 204, written in Java for example, may include a source Java OM. A code generator may generate a corresponding Python OM, shown as arrow 208. The code generator may be or include a class-level functor from the Java OM to the Python OM. According to one aspect, a first class may be provided, either manually written or obtained by other means. The code generator may be programmed to receive the first class as an input and automatically generate a corresponding second class. The generated Python OM may be an isomorphic representation to the original Java OM, preserving the original OM’s objects and morphisms, here classes and relations.

According to one aspect, the class-level functor is then complemented by instance-level functors, in which from Java instances may be mapped, or translated, to Python instances, shown by arrow 212 and Python instances may be mapped to Java instances, shown by arrow 210. These two functors may delegate to an intermediate representation, described below, which flows from the client to the server and back in a client-server invocation. That invocation may be realized using REST POST, WebSockets, or other communication technologies.

FIG. 3 is a flow diagram of a translation subsystem 300 according to aspects of the present disclosure. As described above, a first object model 302 may be mapped, or translated to a second object model 310 using functors, such as translators 304, 308. Instance-level functors may also similarly map instances from one object model to the other. According to one aspect, each of the translators 304 may delegate to an intermediate representation 306. The intermediate representation 306 may be a translation of the object (or instance) into a format that may be readily reconstituted, or translated, into an object (or instance) for another object model. The intermediate representation may be or include a binary encoding of the object (or instance). In one aspect, the intermediate encoding 306 may be a JSON representation. In another aspect, the intermediate encoding 306 may be an XML representation.

According to one aspect, the translators 304 may implement one or more language parsers configured to extract and structure elements of the object model (e.g., classes and instances) into a structure, such as an abstract syntax tree (AST). In one aspect, the class or instance to be translated may be parsed using a recursive descent parser, which may include or be an LL(1) (left-to-right, leftmost derivation, with 1 lookahead token).

According to one aspect, the AST and/or parsed object or instance, including the attributes, properties and relations, may be reflected in the intermediate representation 306, for example in a JSON representation. According to one aspect, the parsing may include a recursive process to parse the class or instance itself as well as other classes, instances, properties, relations or the like until all properties of the class or instance are reflected in the structure.

It will be appreciated that due to differences in objected-oriented programming languages, certain classes or instances, including primitive types, may not be easily parsed or translated to a corresponding class or instance of another language. For example, the type “integer” may pose difficulty when mapping from Python to Java. In the Python language, there is no practical size limit, while in Java, the integer type is limited to sixty-four bits. In such cases, where incongruities arise, each class may need additional mappings to translate the non-confirming class to one that is readable by the other object model.

The translation subsystem 300 may be bidirectional allowing for object and instance translations from the first object model 302 to the second object model 310 and vice versa from the second object model 310 to the first object model 302. For example, a first instance from the first object model 302 may translated by translator 304 into an intermediate representation 306. The translator 308 may map or reconstitute the intermediate representation 306 as an instance of the second object model 310. Similarly, a second instance from the second object model 310 may translated by translator 308 into an intermediate representation 306. The translator 304 may map or reconstitute the intermediate representation 306 as an instance of the first object model 302.

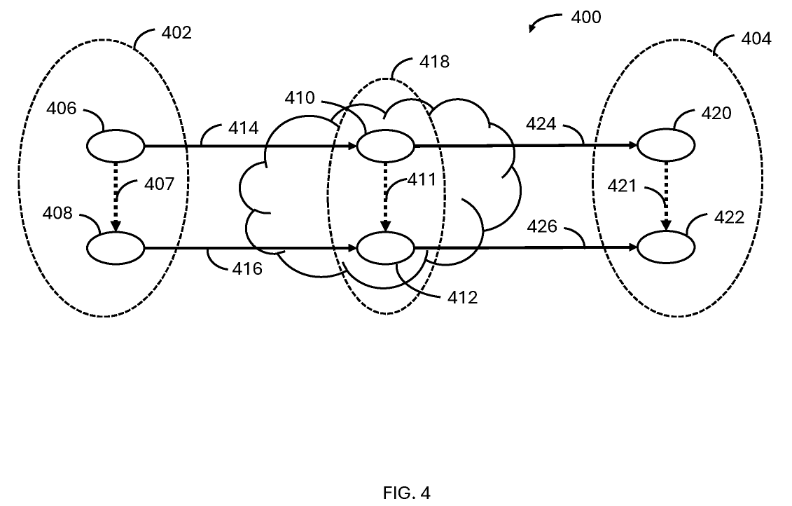

FIG. 4 is a commutative diagram 400 of an API development framework, according to aspects of the present disclosure. The commutative diagram may reflect the conceptual relationship between a first class 406, a first method 407 and first return 408 as represented in a first object model 402 with a second class 420, a second method 421 and second return 422 as represented in a second object model 404. As described herein an intermediate representation 418 may be implemented to provide a class mapping 410, a method mapping 411 and a result mapping 412.

According to one aspect, the mapping of the first class 406 to an intermediate representation class 410 may be characterized as a functor 414, in which all structures and properties of the class are preserved. Similarly, the mapping of the first return 408 to an intermediate return 412 may be characterized by functor 416. Functor 424 may characterize the mapping of the intermediate representation class 410 to the second class 420. Functor 426 may characterize the mapping of the intermediate return 412 to the second return 422. Methods 407, 411 and 412 may be characterized as morphisms between classes within the same category (e.g., object model).

While the details of FIG. 4 may be discussed in reference to a class, such as the first class 406 and the second class 420, one skilled in the art will recognize the concepts described will be the same or similar for instances within the respective object models.

The categorical approach to developing APIs according to the concepts, techniques and structures described herein provide a number technical and practical advantages over known API architectural styles. For one, the server application code now uses a single object model, obviating the shortcomings of creating and maintaining an additional REST OM. Further, APIs developed using the concepts, techniques and structures described herein are stateful. Additionally, because there are no dedicated URLs generated, there is no information leakage. Further yet, versioning of the code may be implemented by following the Liskov Substitution Principle (LSP) in the server.

As another advantage, the application code in the client may be written entirely in a first language (e.g., Python), while application code in the server may be written entirely in a second language (e.g., Java). Significantly, the translation functors described herein may conceal the on-the-wire JSON representation in the communication infrastructure, as illustrated below. This may be accomplished through abstraction of several features of the transport. For example, REST endpoints, HTTPs calls, JSON scheme, JSON, XML schema and XML may be abstracted away through the implementation of the categorical approach and mapping through an intermediate representation.

In addition, according to one aspect, the APIs developed according to the concepts, techniques and structures described herein may replace HTTPS with more performant communication protocols, such as WebSockets. Moreover, since the API development may use the same server functionality as the GUI, no additional testing may be required. Since, according to one example implementation, the Python OM is entirely code generated, API developers do not need to write any OM code.

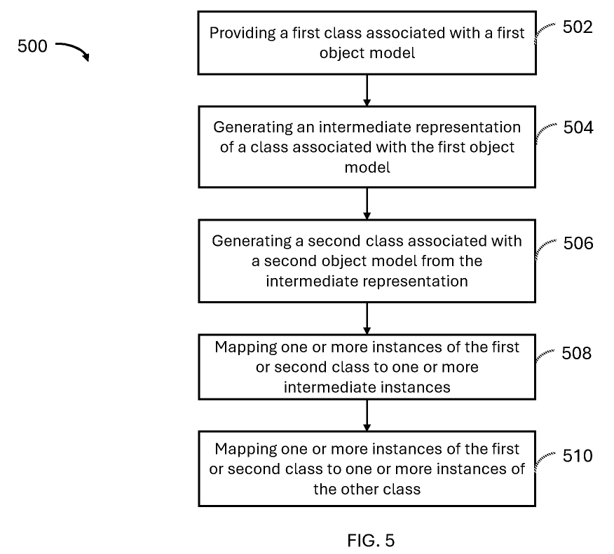

FIG. 5 is a flow diagram of a method of developing an API using a code generator, according to aspects of the present disclosure. According to one aspect, as shown in block 502, a first class associated with an object model may be provided. For example, a Java object model may be provided. Shown in block 504, an intermediate representation of a class associated with the first object model may be generated. The intermediate representation of the class may be, as described herein, a textual encoding of the class as translated using a parser. The textual encoding may be a JSON or XML representation. As shown in block 506 a corresponding second class associated with a second object model may be generated from the intermediate representation. The second class may be a reconstitution of a class in the second object model created from the parsed JSON representation. As shown in block 508, one or more instances of either the first class or the second class may mapped be to one or more intermediate instances using instance-level mappings in a similar manner to the class-level mappings. The intermediate instances may be parsed into a textual encoding, such as a JSON representation. As shown in block 510 the intermediate instances may be mapped to instances associated with the other object model. That is intermediate instances originating from the first object model may be mapped to instances of the second object model and intermediate instances originating from the second object model may be mapped to instances of the first object model.

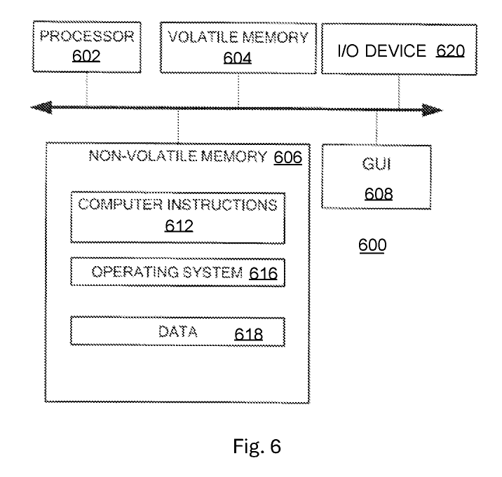

Referring to FIG. 6, in some embodiments, a computing device 600 may include processor 602, volatile memory 604 (e.g., RAM), non-volatile memory 606 (e.g., a hard disk drive, a solid-state drive such as a flash drive, a hybrid magnetic and solid-state drive, etc.), graphical user interface (GUI) 608 (e.g., a touchscreen, a display, and so forth) and input/output (I/O) device 620 (e.g., a mouse, a keyboard, etc.). Non-volatile memory 606 stores computer instructions 612, an operating system 616 and data 618 such that, for example, the computer instructions 612 are executed by the processor 602 out of volatile memory 604. Program code may be applied to data entered using an input device of GUI 608 or received from I/O device 820.

As used herein, the term “I/O request” or simply “I/O” may be used to refer to an input or output request. In some embodiments, an I/O request may refer to a data read or write request.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
providing a first class associated with a first object model;
generating a corresponding second class associated with a second object model using a class-level mapping; and
mapping one or more instances of the second class to one or more instances of the first class using an instance-level mapping,
wherein the class-level mapping and the instance-level mapping comprise a translation to an intermediary representation.

2. The method of claim 1 wherein the intermediary representation is a binary encoding.

3. The method of claim 2 wherein the textual encoding is a JSON representation.

4. The method of claim 1 wherein the first and second object models are object-oriented programming languages.

5. The method of claim 4 wherein the first object model comprises a Java object model and the second object model comprises a Python object model.

6. The method of claim 1 wherein the translation comprises a recursive descent parser.

7. The method of claim 6 wherein the recursive descent parser comprises an LL(1) parser.

8. The method of claim 1 wherein the corresponding second class is isomorphic to the first class.

9. The method of claim 8 wherein the class-level mapping is a functor.

10. A system comprising:
a memory; and
at least one processor that is operatively coupled to the memory, the at least one processor being configured to perform the operations of:
providing a first class associated with a first object model;
generating a corresponding second class associated with a second object model using a class-level mapping; and
mapping one or more instances of the second class to one or more instances of the first class using an instance-level mapping,
wherein the class-level mapping and the instance-level mapping comprise a translation to an intermediary representation.

11. The system of claim 10 wherein the intermediary representation is a binary encoding.

12. The system of claim 11 wherein the textual encoding is a JSON representation.

13. The system of claim 10 wherein the first and second object models are object-oriented programming languages.

14. The system of claim 13 wherein the first object model comprises a Java object model and the second object model comprises a Python object model.

15. The system of claim 10 wherein the translation comprises a recursive descent parser.

16. The system of claim 15 wherein the recursive descent parser comprises an LL(1) parser.

17. The system of claim 10 wherein the corresponding second class is isomorphic to the first class.

18. The system of claim 17 wherein the class-level mapping is a functor.

19. A non-transitory computer-readable medium storing one or more processor-executable instructions, which when executed by at least one processor cause the at least one processor to perform the operations of:
providing a first class associated with a first object model;
generating a corresponding second class associated with a second object model using a class-level mapping; and
mapping one or more instances of the second class to one or more instances of the first class using an instance-level mapping,
wherein the class-level mapping and the instance-level mapping comprise a translation to an intermediary textual encoding.

20. The non-transitory computer-readable medium of claim 19 wherein the instance-level mapping is stateful and does not include a dedicated URL.
